(19) United States
(12) Patent Application Publication
(10) Pub. No.: US 2009/0037734 A1
(43) Pub. Date: Feb. 5, 2009

(54) DEVICE AUTHENTICATION SYSTEM, MOBILE TERMINAL DEVICE, INFORMATION DEVICE, DEVICE AUTHENTICATING SERVER, AND DEVICE AUTHENTICATING METHOD

(75) Inventor: Tsutomu Kito, Kanagawa (JP)

Correspondence Address: Christensen O'Connor Johnson Kindness PLLC, 1420 5th Avenue, Suite 2800, Seattle, WA, 98101, US

(73) Assignee: MATSUSHITA ELECTRIC INDUSTRIAL CO., LTD., Kadoma-shi, Osaka (JP)

(21) Appl. No.: 12/280,984

(22) PCT Filed: Feb. 28, 2006
(86) PCT No.: PCT/JP2006/303775

§ 371 Date: Aug. 27, 2008

(51) Int. Cl. H04L 9/00; G06F 21/00

(52) U.S. Cl. 713/168; 726/4

(57) ABSTRACT

According to a device authentication system (10), an information device (101) carries out authentication processing in a device authenticating server (102) by using user access authorizing information (701) acquired from the device authenticating server (102) by a mobile terminal device (100) to connect services with a mobile communication provider through an IP network (103). As a result, the mobile communication provider which provides the services can identify a user and its using device, and properly comply with service requests from the user.

### TECHNICAL FIELD

The present invention relates to a system that accesses a server on network through coordination between an information device and a mobile terminal. In particular, the present invention relates to a device authentication system, mobile terminal, information device, device authentication server and device authentication method that carry out authentication of an information device coordinated with a mobile terminal on an authentication server.

### BACKGROUND ART

With the rapid spread of the Internet, the number of accesses to servers on network is growing from not only personal computers but also information devices such as Internet-accessible home information appliances. Service providers who provide services from servers on network provide a mechanism of identifying, for example, an Internet service provider from which it is accessed and information of the type of an information device on the Web server and converting a file written in HTML (HyperText Markup Language) to a file format that can be handled by the information device of the accessing source, and a mechanism of identifying the information device of the accessing source on the Web server and performing appropriate access control over specific content, as functions specific to the Internet service providers.

Furthermore, Patent Document 1 describes a device authentication system that identifies the type of a device used using a radio data communication apparatus and provides appropriate service supporting the type of the device. In this device authentication system, an information device has a radio data communication apparatus, and, when the information device is connected to network service through the radio data communication apparatus, the radio data communication apparatus performs authentication using specific information of the information device in addition to normal authentication information.

### Patent Document 1: Japanese Patent Application Laid-Open No. 2004-355562

### DISCLOSURE OF INVENTION

### Problems to be Solved by the Invention

However, in the above-described device authentication system, there may be a case where the information device has a faster Internet connection section than the radio data communication apparatus of the information device, and service, which is provided by the mobile communication provider of the radio data communication apparatus, is used via the faster Internet by the Internet connection section.

In this case, service is not connected after network connection steps being performed by the radio data communication apparatus, and so there is a problem that the mobile communication provider who provides the service cannot identify the user and the type of the information device used and cannot appropriately respond to a user's service request.

The present invention has been implemented in view of the above-described problems and it is therefore an object of the present invention to provide a device authentication system, mobile terminal, information device, device authentication server and device authentication method for providing appropriate service supporting the type of an information device by authenticating a user, the type of the information device used and the individual device through the device authentication server using the mobile terminal owned by the user such as a mobile telephone.

### Means for Solving the Problem

The device authentication system of the present invention employs a configuration having: a mobile terminal that includes: a first communication connection section connected to first communication network; a device-specific information input section that acquires device-specific information from an information device; a device information acquisition section that acquires device-specific user access authority information to use predetermined service from the device authentication server by sending the device-specific information to a device authentication server through the first communication connection section via the first communication network; a second communication connection section connected to second communication network; and an authority information reporting section that reports the user access authority information to the information device through the second communication connection section via the second communication network; and an information device that includes: a second communication connection section connected to the second communication network; a third communication connection section connected to third communication network; a device information storage section that stores device-specific information; a device-specific information output section that outputs device-specific information; an authority information acquisition section that acquires device-specific user access authority information to use predetermined service from the mobile terminal by reporting the device-specific information to the mobile terminal via the second communication network through the second communication connection section; and a service connection section that sends the user access authority information to the device authentication server to access the service via the third communication network through the third communication connection section; and a device authentication server that includes: a first communication connection section connected to the first communication network; a third communication connection section connected to the third communication network; an authority information generation section that generates device-specific user access authority information to use predetermined service by acquiring the device-specific information from the mobile terminal via the first communication network through the first communication connection section; an authority information reporting section that reports the generated user access authority information to the mobile terminal via the first communication network through the first communication connection section; and a device information authentication section that acquires user access authority information from the information device via the third communication network through the third communication connection section and decides whether to accept or reject access to the service.

Furthermore, the mobile terminal of the present invention that accesses a device authentication server via first communication network, accesses an information device via second communication network and executes communication processing related to device authentication of the information device, employs a configuration having: a first communication connection section connected to the first communication network; a second communication connection section connected to the second communication network; a storage medium loading and unloading section that loads and unloads a portable storage medium; a device information acquisition section that acquires device-specific information from the information device via the second communication network through the second communication connection section, sends the device-specific information to the device authentication server via the first communication network through the first communication connection section, and thereby acquires device-specific user access authority information to use predetermined service from the device authentication server; an encryption section that encrypts the user access authority information according to the device-specific information and stores the encrypted user access authority information in the storage medium loaded on the storage medium loading and unloading section; and an authority information reporting section that reports the user access authority information to the information device via the second communication network or through the storage medium by the second communication connection.

Furthermore, the information device of the present invention that accesses a mobile terminal via second communication network, accesses a device authentication server via third communication network and executes communication processing related to device authentication, employs a configuration having: a second communication connection section connected to the second communication network; a third communication connection section connected to the third communication network; a device information storage section that stores device-specific information; a storage medium loading and unloading section that loads and unloads a portable storage medium; an authority information acquisition section that reports the device-specific information to the mobile terminal via the second communication network through the second communication connection section, and thereby acquires device-specific user access authority information to use predetermined service from the mobile terminal via the second communication network or through the storage medium loaded on the storage medium loading and unloading section; and a service connection section that sends the user access authority information to the device authentication server to access the service via the third communication network through the third communication connection section.

Furthermore, the device authentication server of the present invention that connects with a mobile terminal via first communication network, connects with an information device via third communication network and executes communication processing related to device authentication of the information device, employs a configuration having: a first communication connection section connected to the first communication network; a third communication connection section connected to the third communication network; an authority information generation section that acquires the device-specific information from the mobile terminal via the first communication network through the first communication connection section and generates device-specific user access authority information to use predetermined service; an authority information reporting section that reports the generated user access authority information via the first communication network through the first communication connection section to the mobile terminal; and a device information authentication section that acquires user access authority information from the information device via the third communication network through the third communication connection section and decides whether to accept or reject access to the service.

Furthermore, the device authentication method of the present invention for a device authentication system containing a mobile terminal, an information device and a device authentication server, employs a configuration having: a device-specific information reporting step of, in the information device, acquiring device-specific information by a device-specific information input section, reporting the device-specific information to the mobile terminal via second communication network through a second communication connection section; a device-specific information reporting step of, in the mobile terminal, acquiring the device-specific information from the information device via the second communication network through a second communication connection section and reporting the device-specific information to the device authentication server via first communication network through a first communication connection section; an authority information generation step of, in the device authentication server, acquiring the device-specific information from the mobile terminal via the first communication network through the first communication connection section and generating device-specific user access authority information to use predetermined service; an authority information reporting step of, in the device authentication server, reporting the generated user access authority information to the mobile terminal via the first communication network through the first communication connection section; an authority information reporting step of, in the mobile terminal, acquiring the user access authority information from the device authentication server via the first communication network through the first communication connection section and reporting the user access authority information to the information device via the second communication network through the second communication connection section; an authority information acquisition step of, in the information device, acquiring the user access authority information from the mobile terminal via the second communication network through the second communication connection section; a service connection step of, in the information device, sending the user access authority information to the device authentication server to access the service via a third communication network through a third communication connection section; and a device information authentication step of, in the device authentication server, acquiring the user access authority information from the information device via the third communication network through the third communication connection section and deciding whether to accept or reject access to the service.

### ADVANTAGEOUS EFFECT OF THE INVENTION

According to the present invention, by authenticating a user, the type of an information device used and the individual device through a device authentication server using a mobile terminal owned by the user such as a mobile telephone, it is possible to provide appropriate service supporting the type of the information device.

### BRIEF DESCRIPTION OF DRAWINGS

FIG. 1 shows an overall configuration of a device authentication system according to Embodiment 1 of the present invention;

FIG. 2 is a block diagram showing a configuration of a mobile terminal according to Embodiment 1;

FIG. 3 is a block diagram showing a configuration of an information device according to Embodiment 1;

FIG. 4 is a block diagram showing a configuration of a device authentication server according to Embodiment 1;

FIG. 5 is a block diagram showing a configuration of a storage medium according to Embodiment 1;

FIG. 6 is a block diagram showing a configuration of a storage medium loading and unloading section of the mobile terminal according to Embodiment 1;

FIG. 7 shows the logical configuration of user access authority information according to Embodiment 1;

FIG. 8 is a sequence diagram showing the operation of a device authentication system according to Embodiment 1; and

FIG. 9 is a sequence diagram showing the operation of a device authentication system according to Embodiment 2 of the present invention.

### BEST MODE FOR CARRYING OUT THE INVENTION

Embodiments of the present invention will be explained below in detail with reference to the accompanying drawings. Components and corresponding parts having the same configurations or functions among the drawings will be assigned the same reference numerals and explanations thereof will not be repeated.

### Embodiment 1

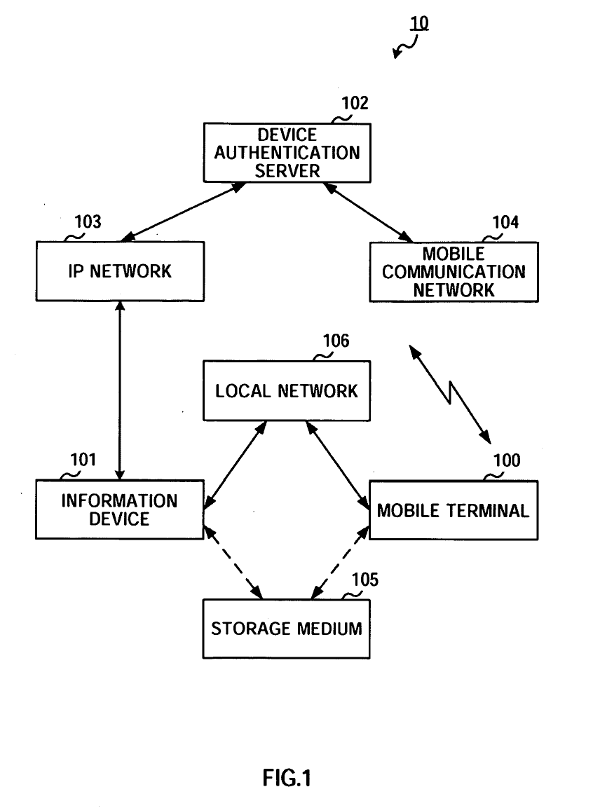

FIG. 1 shows an overall configuration of a device authentication system according to Embodiment 1 of the present invention. In FIG. 1, device authentication system 10 is configured with mobile terminal 100, information device 101 that transmits and receives data to and from mobile terminal 100 through local network 106 or storage medium 105 and device authentication server 102 connected to mobile communication network 104 and IP network 103.

Suppose that mobile terminal 100 is a mobile telephone that accesses service of a mobile communication provider provided on IP network 103 (third communication network) via mobile communication network 104 (first communication network).

Information device 101 is a device having an IP network connection function and is a home information appliance such as a personal computer, DVD recorder and network camera.

Device authentication server 102 is an authentication server group for performing authentication steps when information device 101 connects to service that is provided by a mobile communication provider and that is connected to mobile terminal 100 via mobile communication network 104, via IP network 103. This device authentication server 102 provides functions of, for example, an authentication station and attribute authentication station in X.509 PKI (Public Key Infra structure).

Storage medium 105 refers to, for example, a memory card that can be mounted on mobile terminal 100 and information device 101. Storage medium 105 has authentication section 501 and storage section 502 as shown in FIG. 5.

Local network 106 (second communication network) is used to perform data transmission and reception between mobile terminal 100 and information device 101 in a wired or wireless way. Examples of local network 106 include USB (Universal Serial Bus), WLAN (wireless LAN), Ethernet (registered trademark) and NFC (Near Field Communication).

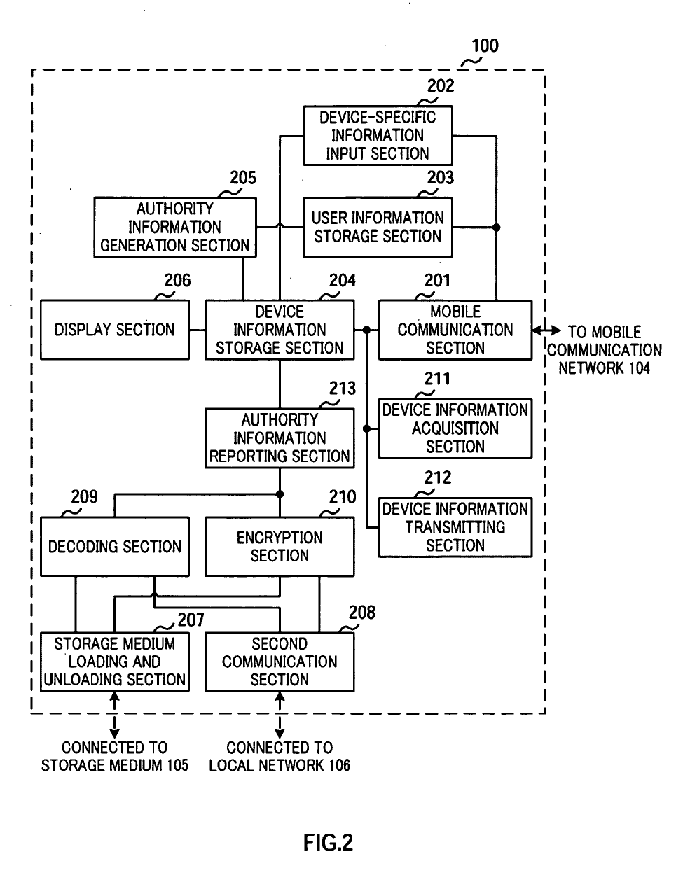

FIG. 2 is a block diagram showing a configuration of mobile terminal 100 in FIG. 1. In FIG. 2, mobile terminal 100 is configured with mobile communication section 201 which is the first communication connection means, device-specific information input section 202, user information storage section 203, device information storage section 204, authority information generation section 205, display section 206, storage medium loading and unloading section 207, second communication section 208 which is the second communication connection means, decoding section 209, encryption section 210, device information acquisition section 211, device information transmitting section 212 and authority information reporting section 213.

Mobile communication section 201 has a wireless communication function of executing, for example, communication steps related to communication with another mobile terminal (mobile telephone) via mobile communication network 104, and communication steps related to authentication for receiving service provided by a mobile communication provider.

Device-specific information input section 202 is an input means to input device-specific information of information device 101 such as key input of a mobile telephone and input by a camera function. Examples of the device-specific information include a serial number by a manufacturer of information device 101, an ID uniquely provided by the manufacturer and a MAC (Media Access Control) address in the Ethernet (registered trademark).

User information storage section 203 is a memory to store information (such as telephone number, address and name) of the user who uses mobile terminal 100.

Device information storage section 204 is a memory to store device-specific information for user authentication when information device 101 connects to service via IP network 103.

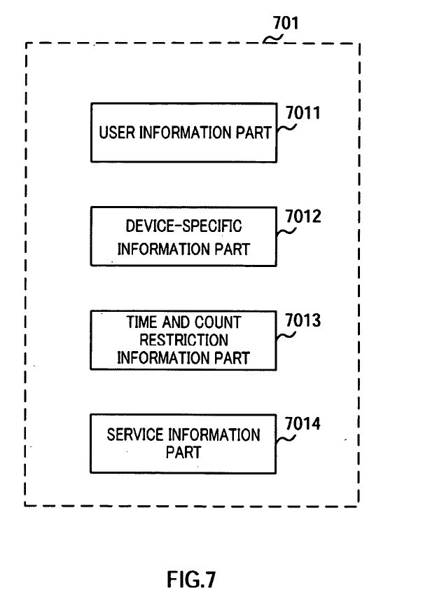

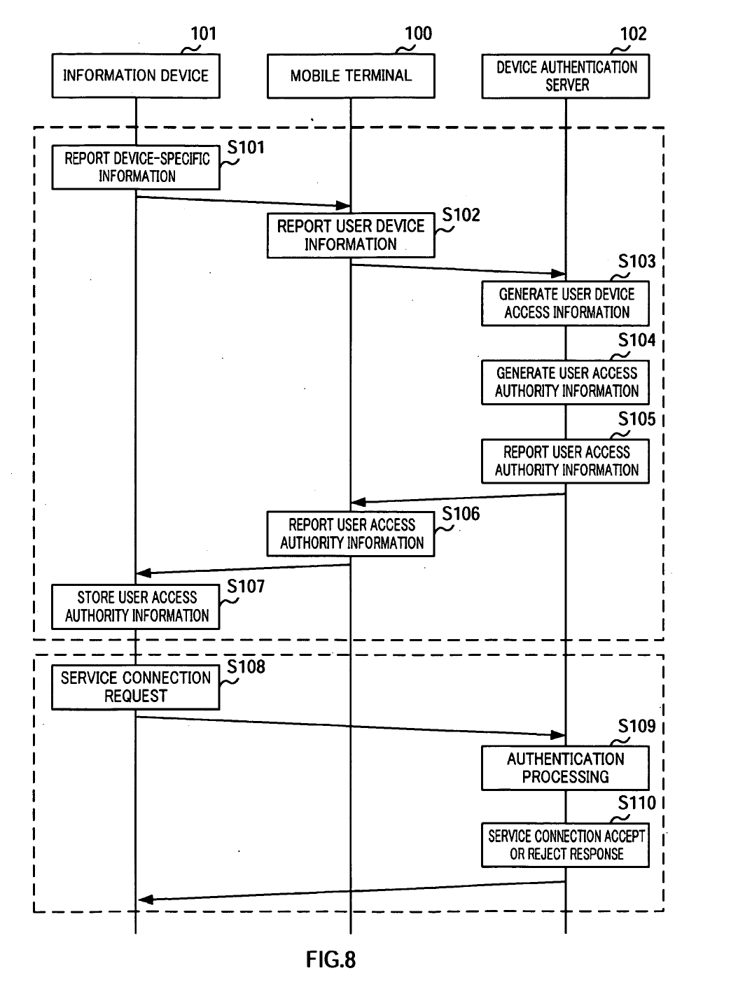

Device information acquisition section 211 acquires user access authority information 701 (see FIG. 7) information device 101 requires for accessing service of the mobile communication provider via IP network 103, from device authentication server 102 via mobile communication network 104.

Device information transmitting section 212 transmits user access authority information 701 to device authentication server 102 via mobile communication network 104.

Authority information generation section 205 generates user access authority information 701 (see FIG. 7) information device 101 requires for accessing service of the mobile communication provider via IP network 103.

Display section 206 displays information for user authentication or the like stored in device information storage section 204.

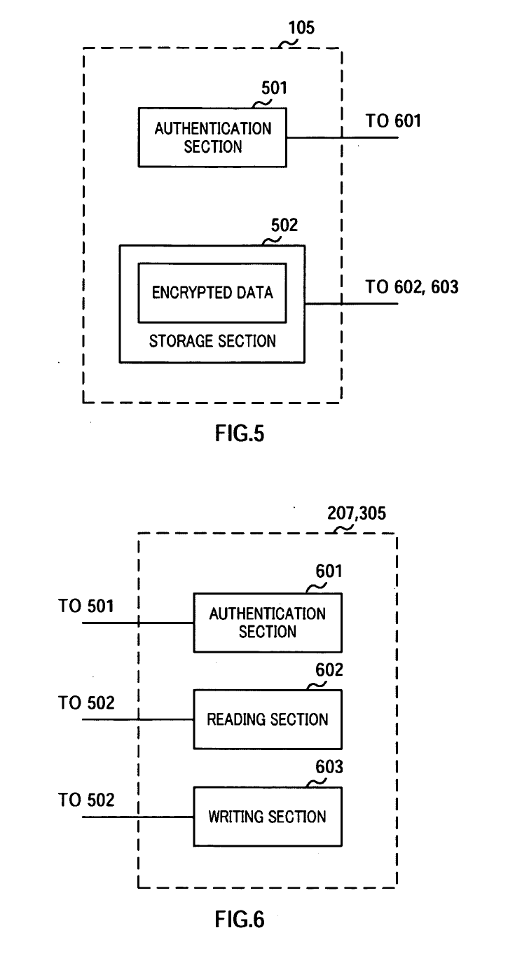

As shown in FIG. 6, storage medium loading and unloading section 207 has authentication section 601, reading section 602 and writing section 603. When storage medium 105 is loaded, storage medium loading and unloading section 207 performs mutual authentication in both authentication sections 601 and 501, and can perform read and write operation from and to storage section 502 in storage medium 105, through reading section 602 and writing section 603.

Second communication section 208 has a communication function for transmitting and receiving data to and from information device 101 via local network 106.

Authority information reporting section 213 reports user access authority information 701 to information device 101 by second communication section 208. Alternatively, authority information reporting section 213 memory-transfers user access authority information 701 to storage medium 105 loaded on storage medium loading and unloading section 207.

Decoding section 209 decodes encrypted data read from storage medium 105 by storage medium loading and unloading section 207 or encrypted data received from information device 101 by second communication section 208.

Encryption section 210 reads information for authentication from device information storage section 204, encrypts the information and outputs the encrypted information to storage medium loading and unloading section 207 or second communication section 208.

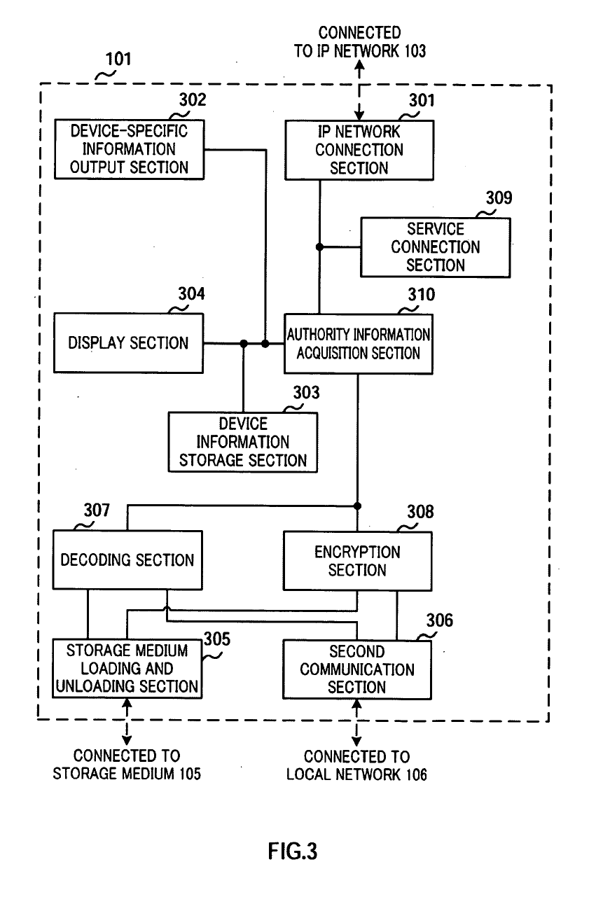

Next, the configuration of information device 101 will be explained using FIG. 3. In FIG. 3, information device 101 is configured with IP network connection section 301, which is the third communication connection means, device-specific information output section 302, device information storage section 303, display section 304, storage medium loading and unloading section 305, second communication section 306, decoding section 307, encryption section 308, service connection section 309 and authority information acquisition section 310.

IP network connection section 301 is a means for connecting to IP network 103. Service connection section 309 executes, for example, communication steps required for device authentication with device authentication server 102 to access service of the mobile communication provider via IP network 103.

Device-specific information output section 302 is an output means to output the device-specific information of information device 101, such as a serial number, barcode and two-dimensional barcode, to outside.

Authority information acquisition section 310 acquires user access authority information 701 from mobile terminal 100 via local network 106. Alternatively, authority information acquisition section 310 acquires user access authority information 701 by loading storage medium 105 that stores user access authority information 701 on storage medium loading and unloading section 305 and memory-transferring the information into information device 101.

Device information storage section 303, display section 304, storage medium loading and unloading section 305, second communication section 306, decoding section 307 and encryption section 308 have functions similar to those in the blocks explained in the configuration of mobile terminal 100, and so explanations thereof will be omitted.

An overview of the operation of sending and receiving user access authority information 701 to and from storage medium 105 will be explained. Mobile terminal 100 requests user access authority information 701 from information device 101 via local network 106 through second communication section 208, carries out processing of encrypting, upon acquiring user access authority information 701 from information device 101, acquired user access authority information 701 using an encryption key, source of which is the previously acquired device-specific information, through encryption section 210 and writes the encrypted information into storage medium 105 loaded on storage medium loading and unloading section 207.

Then, storage medium 105 is loaded on storage medium loading and unloading section 305 of information device 101. Alternatively, encrypted user access authority information 701 is transmitted to information device 101 via local network 106 through second communication section 208.

Information device 101 reads encrypted user access authority information 701 from storage medium 105, decodes the information using an encryption key, source of which is the device-specific information of information device 101, and stores the decoded information in device information storage section 303. Alternatively, information device 101 decodes encrypted user access authority information 701 received at second communication section 306 using the encryption key, source of which is the device-specific information of information device 101, and stores the decoded information in device information storage section 303.

Further, mobile terminal 100 can acquire user access authority information 701 stored in information device 101 in the totally reverse steps of the steps for acquiring user access authority information 701, from information device 101 and store user access authority information 701 in device information storage section 204.

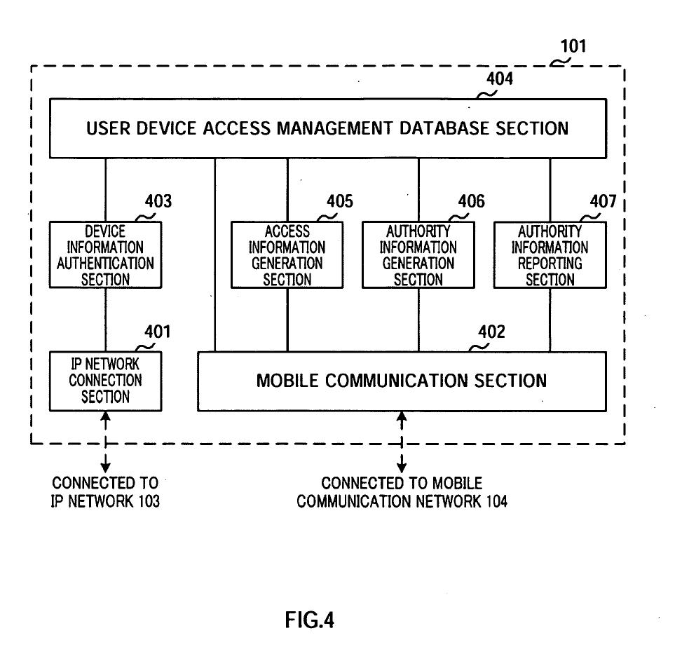

Next, the configuration of device authentication server 102 will be explained using FIG. 4. In FIG. 4, device authentication server 102 is configured with IP network connection section 401, mobile communication section 402, device information authentication section 403, user device access management database section 404, access information generation section 405, authority information generation section 406 and authority information reporting section 407.

IP network connection section 401 has a function of establishing a connection with IP network 103. Device information authentication section 403 executes with information device 101, for example, communication steps required for device authentication to provide service to information device 101 via IP network 103.

Mobile communication section 402 has a function of establishing a connection with mobile communication network 104. Mobile communication section 402 executes, for example, communication steps to receive user device information including user access authority information 701 from mobile terminal 100 via mobile communication network 104.

Device information authentication section 403 verifies user access authority information 701 received from information device 101 using the information of the access authority stored in user device access management database section 404, and thereby authenticates the access to the service of the mobile communication provider of information device 101.

User device access management database section 404 is a database storing information of the user of mobile terminal 100 and the access authority to the service of information device 101. User device access management database section 404 stores information which is generated in mobile terminal 100 or device authentication server 102 and which follows user access authority information 701, described later, per user of mobile terminal 100 as user device access information.

Authority information generation section 406 generates user device access information and user access authority information 701 information device 101 requires for accessing service of the mobile communication provider, from the device-specific information acquired from mobile terminal 100, and stores the information in user device access management database section 404.

Authority information reporting section 407 reports user access authority information 701 generated in authority information generation section 406 to mobile terminal 100 via mobile communication network 104.

Access information generation section 405 generates user device access information from the user device information including user access authority information 701 which is generated in mobile terminal 100 and sent to device authentication server 102, and stores the user device access information in user device access management database section 404.

FIG. 7 shows the logical configuration of user access authority information 701. User access authority information 701 is comprised of user information part 7011, device-specific information part 7012, time and count restriction information part 7013 and service information part 7014.

User information part 7011 includes information of users who use mobile terminal 100. Device-specific information part 7012 includes a serial number by the manufacturer of information device 101, an ID uniquely given by the manufacturer and a MAC address on the Ethernet (registered trademark). Time and count restriction information part 7013 includes information for restricting the time and count upon using service of the mobile communication provider. Service information part 7014 includes information of the service provided by the mobile communication provider.

Next, the operation of device authentication system 10 of Embodiment 1 will be explained with reference to the sequence diagram shown in FIG. 8.

In FIG. 8, mobile terminal 100 requests device-specific information to information device 101 via local network 106 by second communication section 208, and reports (transmits), when the device-specific information is reported from information device 101 (step S101), user device information including the acquired device-specific information to device authentication server 102 via mobile communication network 104 by mobile communication section 201 (step S102).

After receiving user device information from mobile terminal 100 in mobile communication section 402, device authentication server 102 generates user device access information associated with the device-specific information included in the received user device information in access information generation section 405 and also generates user access authority information 701 (steps S103, S104).

Next, device authentication server 102 reports (transmits) generated user access authority information 701 to mobile terminal 100 via mobile communication network 104 in mobile communication section 402 (step S105). Furthermore, device authentication server 102 stores the user device access information in user device access management database section 404.

After mobile communication section 201 of mobile terminal 100 receives user access authority information 701 from device authentication server 102 via mobile communication network 104, second communication section 208 reports (transmits) received user access authority information 701 to information device 101 via local network 106 (step S106). Furthermore, mobile terminal 100 stores received user access authority information 701 in device information storage section 204.

After second communication section 306 of information device 101 receives user access authority information 701 from mobile terminal 100 via local network 106, information device 111 stores received user access authority information 701 in device information storage section 303 (step S107).

Step S101 to step S107 described above show an example of the operation of reporting user device information between information device 101, mobile terminal 100 and device authentication server 102 and the operation of reporting user access authority information.

Next, upon starting a connection to service of the mobile communication provider via IP network 103, information device 101 reads user access authority information 701 from device information storage section 303 and sends a service connection request including this user access authority information 701 to device authentication server 102 via IP network 103 by IP network connection section 301 (step S108).

Device authentication server 102 searches user access authority information 701 which is included in the service connection request received from information device 101 in device information authentication section 403, from user device access management database section 404 and executes authentication processing as to whether to accept or reject the service access (step S109). Next, device authentication server 102 sends a service connection accept or reject response as a result of the authentication processing to information device 101 via IP network 103 through IP network connection section 401 (step S110).

After receiving a service connection accept response, information device 101 can make a connection with the service of the mobile communication provider via IP network 103.

Step S109 to step S110 described above show an example of the operation of accessing the service by information device 101.

As described above, according to device authentication system 10 of Embodiment 1, device authentication server 102 performs authentication processing using user access authority information 701 acquired from device authentication server 102 by mobile terminal 100, so that information device 101 can make a connection with the service by the mobile communication provider via IP network 103.

As a result, the mobile communication provider who provides service can identify the user and the type of the information device used and appropriately respond to a user's service request.

### Embodiment 2

An operation example will be explained in Embodiment 2 where user access authority information 701 is generated in mobile terminal 100 and the user access authority information is reported to information device 101. Here, the configurations of the device authentication system, mobile terminal, information device and device authentication server in Embodiment 2 are the same as those shown in FIG. 1 to FIG. 4 in Embodiment 1, and therefore illustrations and explanations thereof will be omitted.

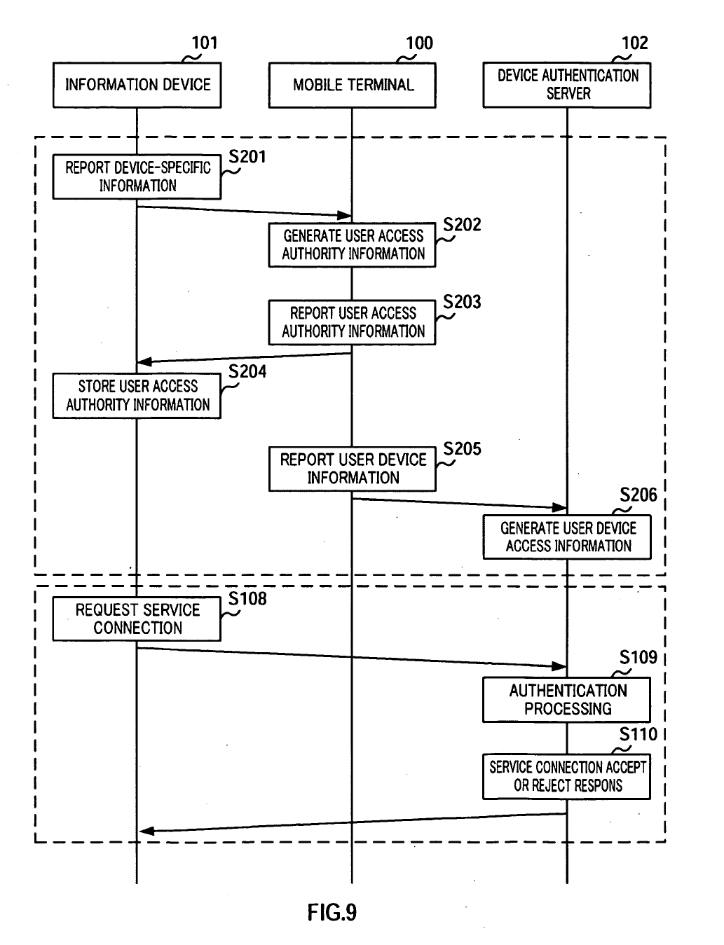

The operation of device authentication system 10 of Embodiment 2 will be explained with reference to the sequence diagram shown in FIG. 9. Here, in the sequence diagram of FIG. 9, the same steps as those in the sequence diagram shown in FIG. 8 are assigned the same reference numerals.

In FIG. 9, mobile terminal 100 requests device-specific information to information device 101 via local network 106 by second communication section 208, combines, when the device-specific information is reported from information device 101 (step S201), the acquired device-specific information and user information stored in user information storage section 203, and thereby generates user access authority information 701 (see FIG. 7) showing that information device 101 can access service of a mobile communication provider (step S202).

Next, mobile terminal 100 stores generated user access authority information 701 in device information storage section 204 and reports (transmits) generated user access authority information 701 to information device 101 via local network 106 by second communication section 208 (step S203).

Information device 101 stores user access authority information 701 received from mobile terminal 100 in device information storage section 303 (step S204). After this, mobile terminal 100 transmits user device information logically including generated user access authority information 701 to device authentication server 102 via mobile communication network 104 by mobile communication section 201 (step S205).

After receiving user access authority information 701 from mobile terminal 100, device authentication server 102 generates user device access information (step S206) and stores the user device access information in user device access management database section 404.

Step S201 to step S206 described above show an example of the operation of reporting user device information between information device 101, mobile terminal 100 and device authentication server 102 and the operation of reporting user access authority information.

The operations in step S108 to step S110 in FIG. 9 are similar to those explained in Embodiment 1 and therefore explanations thereof will be omitted.

As described above, according to device authentication system 10 of Embodiment 2, device authentication server 102 performs authentication processing using user access authority information 701 acquired from mobile terminal 100, so that information device 101 can make a connection with service of the mobile communication provider via IP network 103.

As a result, the mobile communication provider who provides service can identify the user and the type of the information device used, thereby appropriately responding to a user's service request.

The device authentication system according to a first aspect of the present invention employs a configuration having: a mobile terminal that includes: a first communication connection section connected to first communication network; a device-specific information input section that acquires device-specific information from an information device; a device information acquisition section that acquires device-specific user access authority information to use predetermined service from the device authentication server by sending the device-specific information to a device authentication server through the first communication connection section via the first communication network; a second communication connection section connected to second communication network; and an authority information reporting section that reports the user access authority information to the information device through the second communication connection section via the second communication network; and an information device that includes: a second communication connection section connected to the second communication network; a third communication connection section connected to third communication network; a device information storage section that stores device-specific information; a device-specific information output section that outputs device-specific information; an authority information acquisition section that acquires device-specific user access authority information to use predetermined service from the mobile terminal by reporting the device-specific information to the mobile terminal via the second communication network through the second communication connection section; and a service connection section that sends the user access authority information to the device authentication server to access the service via the third communication network through the third communication connection section; and a device authentication server that includes: a first communication connection section connected to the first communication network; a third communication connection section connected to the third communication network; an authority information generation section that generates device-specific user access authority information to use predetermined service by acquiring the device-specific information from the mobile terminal via the first communication network through the first communication connection section; an authority information reporting section that reports the generated user access authority information to the mobile terminal via the first communication network through the first communication connection section; and a device information authentication section that acquires user access authority information from the information device via the third communication network through the third communication connection section and decides whether to accept or reject access to the service.

According to this configuration, a device authentication server authenticates a user, the type of the information device used and the individual device using the mobile terminal owned by the user such as a mobile telephone, thereby providing appropriate service supporting the type of the information device.

In the authentication system according to the above described first aspect, the device authentication system according to a second aspect of the present invention employs a configuration in which the mobile terminal has: an authority information generation section that acquires the device-specific information from the information device via the second communication network and generates the device-specific user access authority information to use the predetermined service; and a device information transmitting section that transmits user device information including the user access authority information to the device authentication server via the first communication network; and in which the device authentication server has an access information generation section that acquires the user device information from the mobile terminal via the first communication network and generates user device access information.

According to this configuration, a device authentication server authenticates a user, the type of the information device used and the individual device using the mobile terminal owned by the user such as a mobile telephone, thereby providing appropriate service supporting the type of the information device.

In the authentication system according to the above described first aspect, the device authentication system according to a third aspect of the present invention employs a configuration in which the mobile terminal has: a storage medium loading and unloading section that loads and unloads a portable storage medium; and an encryption section that encrypts the user access authority information using the device-specific information as a key and stores the encrypted user access authority information in the storage medium loaded on the storage medium loading and unloading section; the authority information reporting section reports the encrypted user access authority information to the information device via the second communication network or through the storage medium; the information device has a storage medium loading and unloading section that loads and unloads a portable storage medium; and the authority information acquisition section acquires the encrypted user access authority information via the second communication network or through the storage medium loaded on the storage medium loading and unloading section, from the mobile terminal, and has a decoding section that decodes the encrypted user access authority information using the device-specific information of the information device as a key.

According to this configuration, it is possible to improve reliability of user access authority information reported from a mobile terminal to an information device.

The mobile terminal according to a fourth aspect of the present invention that accesses a device authentication server via first communication network, accesses an information device via second communication network and executes communication processing related to device authentication of the information device, employs a configuration having: a first communication connection section connected to the first communication network; a second communication connection section connected to the second communication network; a storage medium loading and unloading section that loads and unloads a portable storage medium; a device information acquisition section that acquires device-specific information from the information device via the second communication network through the second communication connection section, sends the device-specific information to the device authentication server via the first communication network through the first communication connection section, and thereby acquires device-specific user access authority information to use predetermined service from the device authentication server; an encryption section that encrypts the user access authority information according to the device-specific information and stores the encrypted user access authority information in the storage medium loaded on the storage medium loading and unloading section; and an authority information reporting section that reports the user access authority information to the information device via the second communication network or through the storage medium by the second communication connection

According to this configuration, it is possible to provide to the information device using the mobile terminal owned by the user such as a mobile telephone, user access authority information generated in the device authentication server to authenticate the user, the type of the information device used and the individual device.

In the mobile terminal according to the above described fourth aspect, the mobile terminal according to a fifth aspect of the present invention employs a configuration further having: an authority information generation section that acquires the device-specific information from the information device via the second communication network and generates the device-specific user access authority information to use the predetermined service; and a device information transmitting section that transmits user device information including the user access authority information to the device authentication server via the first communication network.

According to this configuration, the information device carries out authentication processing by the device authentication server using the user access authority information acquired from a mobile terminal, thereby making a connection with service of the mobile communication provider via communication network such as IP network.

The information device according to a sixth aspect of the present invention that accesses a mobile terminal via second communication network, accesses a device authentication server via third communication network and executes communication processing related to device authentication, employs a configuration having: a second communication connection section connected to the second communication network; a third communication connection section connected to the third communication network; a device information storage section that stores device-specific information; a storage medium loading and unloading section that loads and unloads a portable storage medium; an authority information acquisition section that reports the device-specific information to the mobile terminal via the second communication network through the second communication connection section, and thereby acquires device-specific user access authority information to use predetermined service from the mobile terminal via the second communication network or through the storage medium loaded on the storage medium loading and unloading section; and a service connection section that sends the user access authority information to the device authentication server to access the service via the third communication network through the third communication connection section.

According to this configuration, the information device carries out authentication processing by the device authentication server using the user access authority information acquired from a mobile terminal, thereby making a connection with service of the mobile communication provider via communication network such as IP network.

The device authentication server according to a seventh aspect of the present invention that connects with a mobile terminal via first communication network, connects with an information device via third communication network and executes communication processing related to device authentication of the information device, employs a configuration having: a first communication connection section connected to the first communication network; a third communication connection section connected to the third communication network; an authority information generation section that acquires the device-specific information from the mobile terminal via the first communication network through the first communication connection section and generates device-specific user access authority information to use predetermined service; an authority information reporting section that reports the generated user access authority information via the first communication network through the first communication connection section to the mobile terminal; and a device information authentication section that acquires user access authority information from the information device via the third communication network through the third communication connection section and decides whether to accept or reject access to the service.

According to this configuration, the information device carries out authentication processing by the device authentication server using the user access authority information acquired from the mobile terminal, thereby making a connection with service of the mobile communication provider via communication network such as IP network.

In the device authentication server according to the above described seventh aspect, the device authentication server according to an eighth aspect of the present invention employs a configuration further having an access information generation section that acquires the user device information from the mobile terminal via the first communication network and generates user device access information.

According to this configuration, the device authentication server can appropriately decide the type and function or the like of the information device owned by the user of the mobile terminal when the information device accesses the device authentication server.

In the device authentication server according to the above described seventh aspect, the device authentication server according to a ninth aspect of the present invention employs a configuration further having a user device access management section that manages a database that stores the user access authority information per user of the mobile terminal and employs the configuration in which the device information authentication section searches the database when the user access authority information is acquired from the information device via the third communication network and decides whether to accept or reject access to the service.

According to this configuration, the device authentication server can appropriately decide whether to accept or reject the user access authority information when the information device owned by the user of the mobile terminal accesses the device authentication server, so that it is possible to prevent unauthorized access to the service.

The device authentication method according to a tenth aspect of the present invention for a device authentication system containing a mobile terminal, an information device and a device authentication server, employs a configuration having: a device-specific information reporting step of, in the information device, acquiring device-specific information by a device-specific information input section, reporting the device-specific information to the mobile terminal via second communication network through a second communication connection section; a device-specific information reporting step of, in the mobile terminal, acquiring the device-specific information from the information device via the second communication network through a second communication connection section and reporting the device-specific information to the device authentication server via first communication network through a first communication connection section; an authority information generation step of, in the device authentication server, acquiring the device-specific information from the mobile terminal via the first communication network through the first communication connection section and generating device-specific user access authority information to use predetermined service; an authority information reporting step of, in the device authentication server, reporting the generated user access authority information to the mobile terminal via the first communication network through the first communication connection section; an authority information reporting step of, in the mobile terminal, acquiring the user access authority information from the device authentication server via the first communication network through the first communication connection section and reporting the user access authority information to the information device via the second communication network through the second communication connection section; an authority information acquisition step of, in the information device, acquiring the user access authority information from the mobile terminal via the second communication network through the second communication connection section; a service connection step of, in the information device, sending the user access authority information to the device authentication server to access the service via a third communication network through a third communication connection section; and a device information authentication step of, in the device authentication server, acquiring the user access authority information from the information device via the third communication network through the third communication connection section and deciding whether to accept or reject access to the service.

According to this method, the device authentication server authenticates the user, the type of the information device used and the individual device using the mobile terminal owned by the user such as a mobile telephone, so that it is possible to provide appropriate service supporting the type of the information device.

### INDUSTRIAL APPLICABILITY

The present invention authenticates a user, the type of an information device used and an individual device by a device authentication server using a mobile terminal owned by the user such as a mobile telephone and is suitable for use in a device authentication system or the like that makes it possible to provide appropriate service supporting the type of the information device.

1. A device authentication system comprising a mobile terminal, an information device and a device authentication server, the mobile terminal and the device authentication server being connected to first communication network, the mobile terminal and the information device being connected to second communication network, and the information device and the device authentication server being connected to third communication network, the device authentication system comprising:
the mobile terminal that comprises:
a device information acquisition section that acquires device-specific information from the information device via the second communication network, transmits the device-specific information to the device authentication server via the first communication network, and thereby acquires device-specific user access authority information including information of available service and information of restrictions on a time or the number of times the service can be used, from the device authentication server; and
an authority information reporting section that reports the user access authority information to the information device via the second communication network;
the information device that comprises:
a device information storage section that stores the device-specific information;
an authority information acquisition section that acquires the device-specific user access authority information to use predetermined service from the mobile terminal by reporting the device-specific information to the mobile terminal via the second communication network; and
a service connection section that transmits the user access authority information to the device authentication server to access the service via the third communication network; and
the device authentication server that comprises:
an authority information generation section that acquires the device-specific information from the mobile terminal via the first communication network and generates the device-specific user access authority information to use the predetermined service;
an authority information reporting section that reports the generated user access authority information to the mobile terminal via the first communication network; and
a device information authentication section that acquires the user access authority information from the information device via the third communication network and decides whether to accept or reject access to the service.

2. A device authentication system comprising a mobile terminal, an information device and a device authentication server, the mobile terminal and the device authentication server being connected to first communication network, the mobile terminal and the information device being connected to second communication network and the information device and the device authentication server being connected to third communication network, the device authentication system comprising:
the mobile terminal that comprises:
an authority information generation section that acquires device-specific information from the information device via the second communication network and generates device-specific user access authority information including information of available service and information of restrictions on a time or the number of times the service can be used; and
an authority information reporting section that reports the user access authority information to the information device via the second communication network;
the information device that comprises:
a device information storage section that stores the device-specific information;
an authority information acquisition section that reports the device-specific information to the mobile terminal via the second communication network, and thereby acquires the device-specific user access authority information to use predetermined service from the mobile terminal; and
a service connection section that transmits the user access authority information to the device authentication server to access the service via the third communication network; and
the device authentication server that comprises:
an access information generation section that acquires the user device information from the mobile terminal via the first communication network and generates user device access information; and
a device information authentication section that acquires the user access authority information from the information device via the third communication network and decides whether to accept or reject access to the service.

3. The device authentication system according to claim 1, wherein:
the mobile terminal comprises:
a storage medium loading and unloading section that loads and unloads a portable storage medium; and
an encryption section that encrypts the user access authority information using the device-specific information as a key and stores the encrypted user access authority information in the storage medium loaded on the storage medium loading and unloading section;
the authority information reporting section reports the encrypted user access authority information to the information device via the second communication network or through the storage medium;
the information device comprises a storage medium loading and unloading section that loads and unloads a portable storage medium; and
the authority information acquisition section acquires the encrypted user access authority information via the second communication network or through the storage medium loaded on the storage medium loading and unloading section, from the mobile terminal, and comprises a decoding section that decodes the encrypted user access authority information using the device-specific information of the information device as a key.

4. A mobile terminal that accesses a device authentication server via first communication network, accesses an information device via second communication network and executes communication processing related to device authentication of the information device, the mobile terminal comprising:
a storage medium loading and unloading section that loads and unloads a portable storage medium;
a device information acquisition section that acquires device-specific information from the information device via the second communication network, transmits the device-specific information to the device authentication server via the first communication network, and thereby acquires device-specific user access authority information including information of available service and information of restrictions on a time or the number of times the service can be used, from the device authentication server;
an encryption section that encrypts the user access authority information according to the device-specific information and stores the encrypted user access authority information in the storage medium loaded on the storage medium loading and unloading section; and
an authority information reporting section that reports the user access authority information to the information device via the second communication network or through the storage medium.

5. The mobile terminal according to claim 4, further comprising:
an authority information generation section that acquires the device-specific information from the information device via the second communication network and generates the device-specific user access authority information to use the predetermined service; and
a device information transmitting section that transmits user device information including the user access authority information to the device authentication server via the first communication network.

6. An information device that accesses a mobile terminal via second communication network, accesses a device authentication server via third communication network and executes communication processing related to device authentication, the information device comprising:
a device information storage section that stores device-specific information;
a storage medium loading and unloading section that loads and unloads a portable storage medium;
an authority information acquisition section that reports the device-specific information to the mobile terminal via the second communication network, and thereby acquires device-specific user access authority information including information of available service and information of restrictions on a time or the number of times the service can be used via the second communication network from the mobile terminal or via the storage medium loaded on the storage medium loading and unloading section; and
a service connection section that transmits the user access authority information to the device authentication server to access the service via the third communication network.

7. A device authentication server that connects with a mobile terminal via a first communication network, connects with an information device via third communication network, and thereby executes communication processing related to device authentication, the device authentication server comprising:
an authority information generation section that acquires device-specific information from the mobile terminal via the first communication network and generates device-specific user access authority information including information of available service and information of restrictions on a time or the number of times the service can be used;
an authority information reporting section that reports the generated user access authority information to the mobile terminal via the first communication network; and
a device information authentication section that acquires the user access authority information from the information device via the third communication network and decides whether to accept or reject access to the service.

8. The device authentication server according to claim 7, further comprising an access information generation section that acquires the user device information from the mobile terminal via the first communication network and generates user device access information.

9. The device authentication server according to claim 7, further comprising a user device access management section that manages a database that stores the user access authority information per user of the mobile terminal,
wherein the device information authentication section searches the database when the user access authority information is acquired from the information device via the third communication network and decides whether to accept or reject access to the service.

10. A device authentication method for a device authentication system comprising a mobile terminal, an information device and a device authentication server, the mobile terminal and the device authentication server being connected to first communication network, the mobile terminal and the information device being connected to second communication network and the information device and the device authentication server being connected to third communication network, the method comprising:
a device-specific information reporting step of, in the information device, acquiring device-specific information and reporting the device-specific information to the mobile terminal via the second communication network;
a device-specific information reporting step of, in the mobile terminal, acquiring the device-specific information from the information device via the second communication network and reporting the device-specific information to the device authentication server via the first communication network;
an authority information generation step of, in the device authentication server, acquiring the device-specific information from the mobile terminal via the first communication network and generating device-specific user access authority information including information of available service and information of restrictions on a time or the number of times the service can be used;
an authority information reporting step of, in the device authentication server, reporting the generated user access authority information to the mobile terminal via the first communication network;
an authority information reporting step of, in the mobile terminal, acquiring the user access authority information from the device authentication server via the first communication network and reporting the user access authority information to the information device via the second communication network;
an authority information acquisition step of, in the information device, acquiring the user access authority information from the mobile terminal via the second communication network;
a service connection step of, in the information device, transmitting the user access authority information to the device authentication server to access the service via the third communication network; and
a device information authentication step of, in the device authentication server, acquiring the user access authority information from the information device via the third communication network and deciding whether to accept or reject access to the service.
